(19) United States
(12) Patent Application Publication
(10) Pub. No.: US 2005/0057934 A1
(43) Pub. Date: Mar. 17, 2005

(54) Height adjustable lamp

(76) Inventor: Hsiu Chin Chen, Taichung City (TW)

Correspondence Address: BIRCH STEWART KOLASCH & BIRCH, PO BOX 747, FALLS CHURCH, VA, 22040-0747, US

(21) Appl. No.: 10/662,351

(22) Filed: Sep. 16, 2003

(51) Int. Cl. F21S 8/08

(52) U.S. Cl. 362/413

(57) ABSTRACT

A height adjustable lamp containing a height adjustable mechanism, a lamp head, a base and a cable. The mechanism not only can let the height of the lamp be adjustable but also prevent the cable received therein from being damaged by overly twisted. The height adjustable mechanism contains an inner tube, a positioning device, an outer tube, a fastener, and a sleeve. The positioning device is connected to a rear end of the inner tube. The outer tube has an elongated rail therein. The elongated rail is engaged with the positioning device for preventing the inner tube from rotating in the outer tube. The fastener has plural inward claws at a first end thereof, a threaded portion thereon and a second end mounted to a top end of the outer tube. The sleeve embraces the fastener and the top end of the outer tube. The sleeve has a threaded portion therein and an inclined surface situated above the threaded portion of said sleeve. The lamp head is connected to a top end of the inner tube. The base is mounted to a rear end of the outer tube. The cable is received within the inner tube and electronically connected to the lamp head for providing electric power to the lamp head.

### TECHNICAL FIELD

This invention relates generally to a height adjustable lamp, in particular, to provide a lamp having a height adjustable mechanism that can adjust height of the lamp as well as prevent a cable received therein from being damaged by overly twisted.

### BACKGROUND OF THE INVENTION

One of the methods to save space and fee of delivering or packaging a good is to reduce the size of the good. Separating the good to two or more portions can reduce a height or width of a good and they can be assembled, when used. The height of a floor or a table lamp is usually larger than its width and that makes it inconvenient to be moved. To solve this problem, a conventional table lamp referring to FIG. 9 contains an upper portion and a lower portion. The upper portion contains a lamp head 200 and an upper tube 100. The lower portion contains a base 500 and a lower tube 400. The lamp can be packaged with the two portions separated. When used, the upper portion is threadly connected to the lower portion. However the cable 300 received in the tubes 100, 400 of the lamp is easily damaged because when the upper portion of the lamp is rotated to be threadly connected to the lower portion of the lamp, the cable 300 received in both upper tube 100 and lower tube 400 may be damaged by overly twisted. The two-piece structure of the conventional lamp is only for package or delivery purpose. The conventional lamp doesn't provide a function of adjusting the height of the lamp according to a user's need. Therefore a lamp that can adjust its height without possibly damaged the cable received therein is needed.

### SUMMARY OF INVENTION

It is therefore an objective of the present invention to provide a lamp with its height adjustable according to a user's need.

Another object of the invention is to provide a lamp when the height of the lamp is adjusted, the cable received therein won't be damaged.

The present invention, briefly summarized, in one embodiment discloses a height adjustable lamp. The lamp mainly contains: an inner tube, a positioning device, an outer tube, a fastener, a sleeve, a lamp head, a base, and a cable. The positioning device is connected to a rear end of the inner tube. The outer tube has an elongated rail therein. The elongated rail is engaged with the positioning device for preventing the inner tube from rotating in the outer tube. The fastener has plural inward claws at a first end thereof, a threaded portion thereon and a second end mounted to a top end of the outer tube. The sleeve embraces the fastener and the top end of the outer tube. The sleeve has a threaded portion therein and an inclined surface situated above the threaded portion of the sleeve. The lamp head is connected to a top end of the inner tube. The base is mounted to a rear end of the outer tube. The cable is received within the inner tube and electronically connected to the lamp head for providing electric power to the lamp head. The inner tube is slidably received through the fastener and in the outer tube. The threaded portion of the sleeve is engaged with the threaded portion of the fastener in order the inclined surface of the sleeve can press against the inward claws to hold the inner tube in position.

### BRIEF DESCRIPTION OF DRAWINGS

The invention will be more clearly understood after referring to the following detailed description read in conjunction with the drawings wherein

FIG. 1 is a perspective view of an embodiment of present invention;

FIG. 2 is a exploded view of the embodiment;

FIG. 3 is a cross sectional view of the embodiment when the inner tube is not hold by the claws of the fastener;

FIG. 4 is a cross sectional view of the embodiment when the inner tube is hold by the claws of the fastener;

FIG. 5 is a cross sectional view of the embodiment showing how the elongated rail and the slot are engaged.

FIG. 6 is a perspective view of the embodiment showing the differences between the height of the embodiment adjusted before and after;

FIG. 7 is a cross sectional view of another embodiment showing how the inner tube is prevented from rotating.

FIG. 8 is a cross sectional view of further another embodiment showing how the inner tube is prevented from rotating; and

FIG. 9 is a perspective view of a conventional lamp.

### DETAILED DESCRIPTION OF PREFERRED EMBODIMENTS

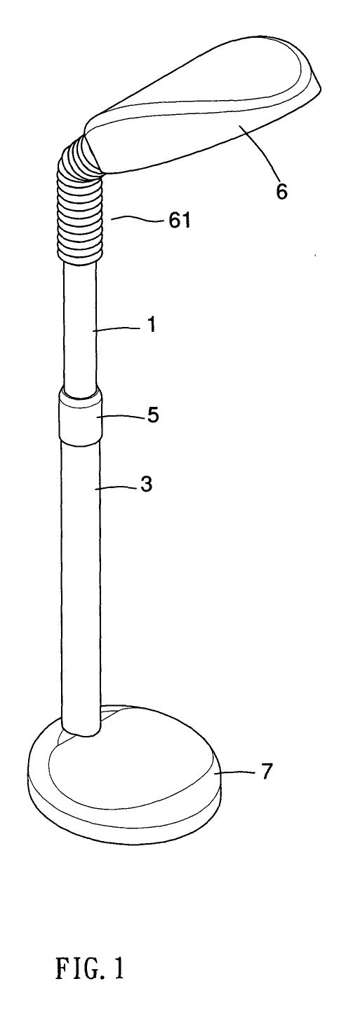

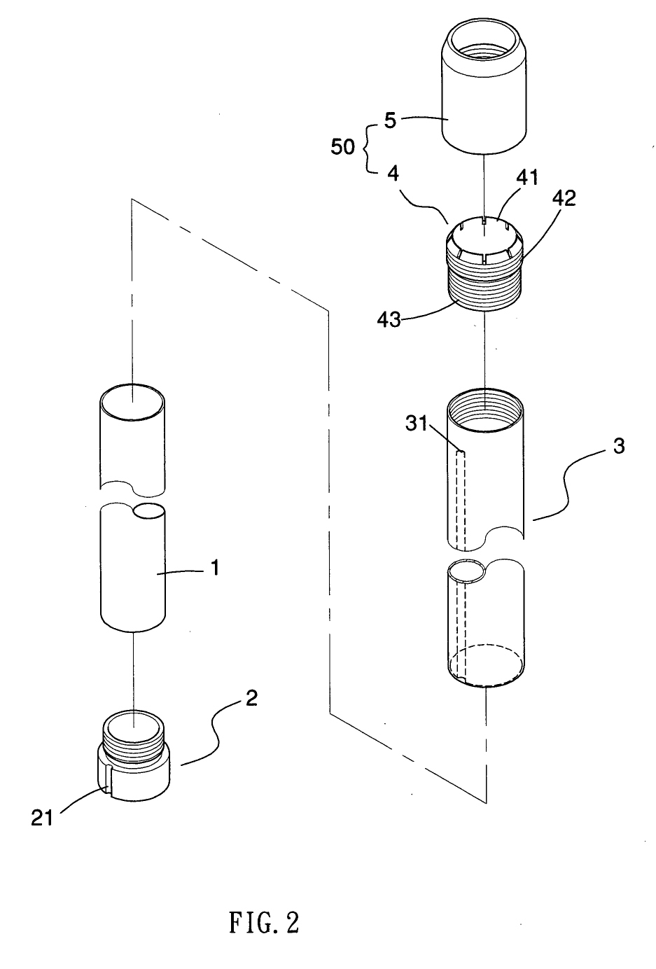

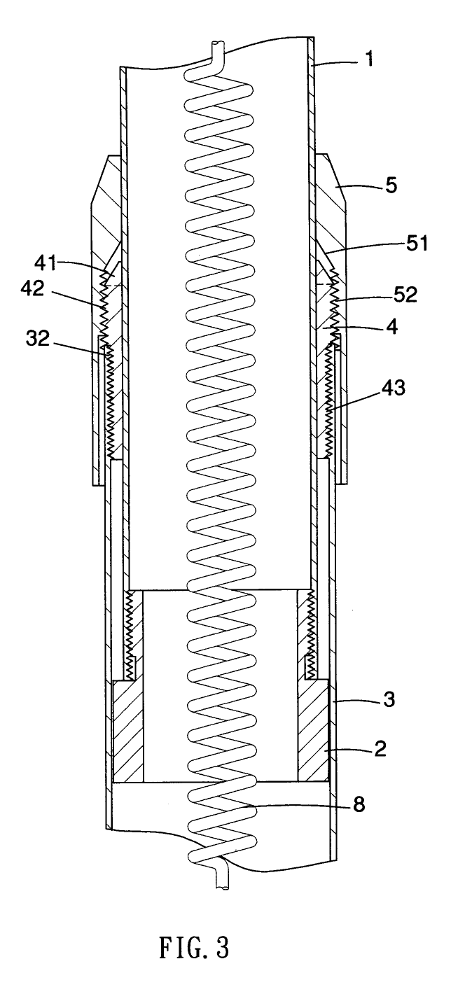

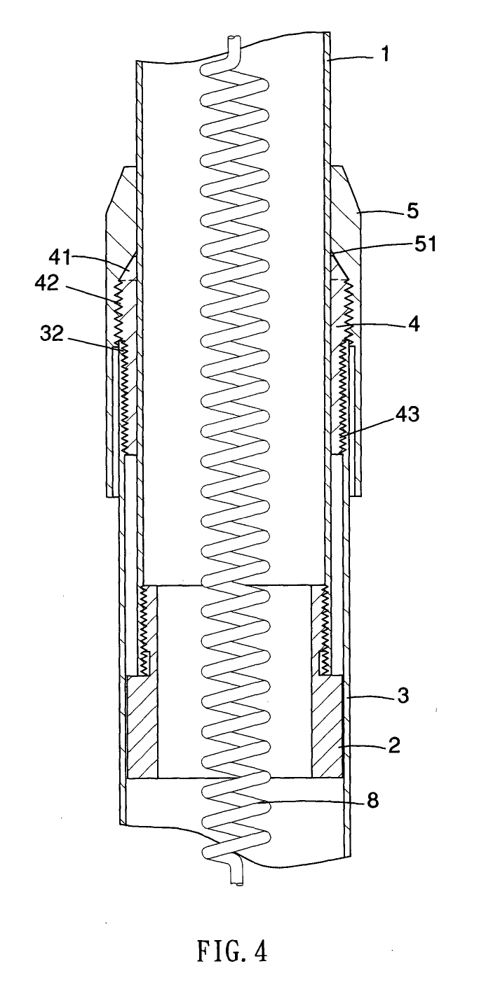

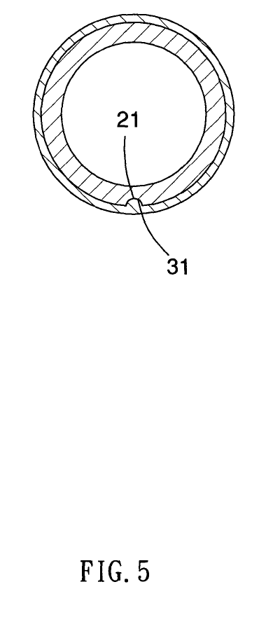

With reference to FIG. 1 to FIG. 5, the height adjustable lamp mainly contains: an inner tube 1, a positioning device 2, an outer tube 3, a fastener 4, a sleeve 5, a lamp head 6, a base 7, and a spiral cable 8. The positioning device 2 containing a slot 21 thereon is threadly connected to a rear end of the inner tube 1. The outer tube 3 has an elongated rail 31 installed longitudely along an inner surface thereof. Referring to FIG. 2 and FIG. 5, the elongated rail 31 is engaged with the slot 21 of the positioning device 2 for allowing the inner tube 1 to move only vertically and preventing the inner tube 1 from rotating in the outer tube 3. The spiral cable 8 sometimes contacts inner surfaces of the inner tube 1. Without the slot 21 engaged with the elongated rail 31, once the inner tube rotates, the spiral cable 8 is dragged to rotate and the spiral cable 8 may be damaged by overly twisted. The fastener 4 has plural flexible inward claws 41 at a first end thereof, a threaded portion 42 thereon and a second end 43 threadly engaged with a top end 32 of the outer tube 3. The sleeve 5 embraces the fastener 4 and the top end 32 of the outer tube 3. The sleeve 5 has an inclined surface 51 and a threaded portion 52 therein. The inclined surface 51 is situated above the threaded portion 52. The lamp head 6 is connected to a top end of the inner tube 1. The lamp head 6 contains a joint portion 61 for allowing the lamp head 6 to rotate to desired position. The base 7 is mounted to a rear end of the outer tube 3. The spiral cable 8 is received within the inner tube 1 and electronically connected to the lamp head 6 for providing electric power to the lamp head 6. The inner tube 1 is slidably received through the fastener 4 and in the outer tube 3. The fastener 4 incorporated with the sleeve 5 is the means 50 for fastening the inner tube 1 to the outer tube 3.

The threaded end 43 of the fastener 4 is located within the threaded top end 32 of the outer tube 3 and the inner tube move slidably through the fastener 4. Therefore the inner diameter of the fastener 4 is larger than the outer diameter of the inner tube 1. The positioning device 2 has an outer diameter larger than the outer diameter of the inner tube 1. Hence, the threaded second end 43 blocks the positioning device 2, and the positioning device 2 will not slide off the outer tube 3.

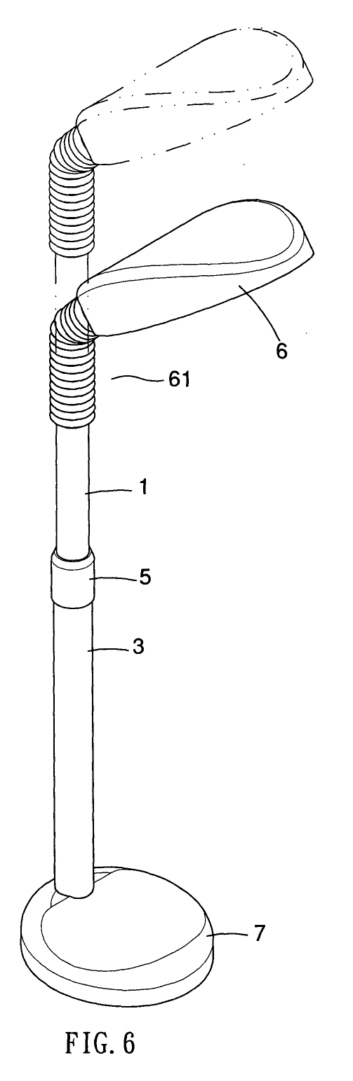

When the fastener 4 is not engaged with the sleeve 5, the inner tube 1 is released from being held by the inward claws 41 of the fastener 4 and the inner tube 1 can move freely. When rotating the sleeve 5 tightens the fastener 4, the threaded portion 52 of the sleeve 5 is engaged with the threaded portion 42 of the fastener 4 in order the inclined surface 51 of the sleeve 5 can press against the inward claws 41 to hold the inner tube 1 in position. Accordingly, a user can adjust the height of the lamp as desired without damaging the spiral cable 8 received therein as showed in FIG. 6.

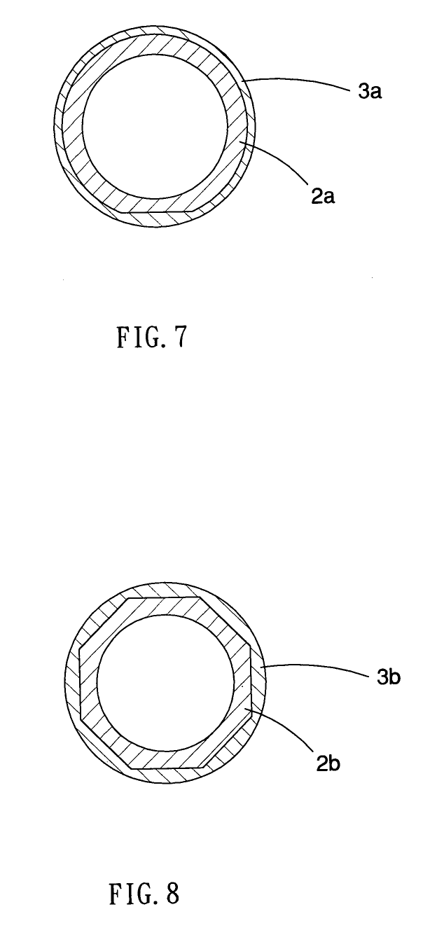

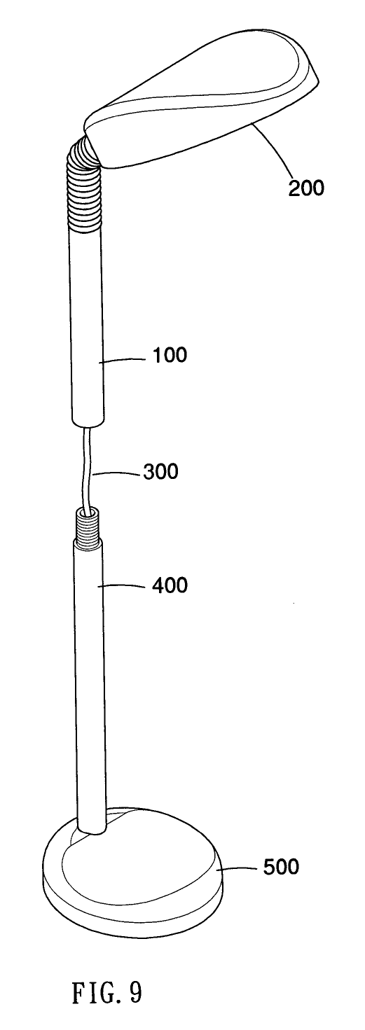

FIG. 7 shows another embodiment of the present invention. The positioning device 2a has a non-circular outer cross section and the outer tube 3a has a same non-circular inner cross section. Since the inner tube 1 is connected to the positioning device 2a, and the positioning device 2a is engaged with the outer tube 3a, the inner tube 1 is restricted from rotating.

Further an embodiment of the present invention is illustrated in FIG. 8. The positioning device 2b has a polygon outer cross-section and the outer tube 3b has a same polygon inner cross-section. Since the inner tube 1 is connected to the positioning device 2b, and the positioning device 2b is engaged with the outer tube 3b, the inner tube is restricted from rotating.

Further another embodiment of the present invention contains a positioning device having a protrusion thereon engaged with a elongated slot rail in the outer tube 3 to prevent the inner tube 1 from rotating in said outer tube 3.

Numerous characteristics and advantages of the invention have been set forth in the foregoing description, together with details of the structure and function of the invention, and the novel features thereof are pointed out in appended claims. The disclosure, however, is illustrated only, and changes may be made in detail, especially, in matters of shape, size and arrangement of parts, materials and the combination thereof within the principle of the invention, to the full extend indicated by the broad general meaning of the terms in which the appended claims are expressed.

1. A height adjustable lamp comprising:
an inner tube;
an outer tube;
a means for fastening said inner tube to said outer tube;
a lamp head connected to a top end of said inner tube; and
a base mounted to a rear end of said outer tube;
wherein said inner tube is slidably received in said outer tube.

2. The height adjustable lamp of claim 1 further comprising a cable received within said inner tube and electronically connected to said lamp head for providing electric power to said lamp head.

3. The height adjustable lamp as claimed in claim 2, wherein said cable is a spiral cable.

4. The height adjustable lamp as claimed in claim 2, wherein said means for fastening said inner tube to said outer tube comprises:
a fastener having plural inward claws at a first end thereof; a threaded portion thereon and a second end mounted to a top end of said outer tube; and
a sleeve embracing said fastener and said top end of said outer tube, said sleeve having a threaded portion therein and an inclined surface situated above said threaded portion of said sleeve;
wherein said inner tube is slidably received through said fastener and in said outer tube, said threaded portion of said sleeve being engaged with said threaded portion of said fastener, in order said inclined surface of said sleeve can press against said inward claws to hold said inner tube in position.

5. A height adjustable lamp comprising:
an inner tube;
a positioning device connected to a rear end of said inner tube;
an outer tube having an elongated rail therein, said elongated rail engaging with said positioning device for preventing said inner tube from rotating in said outer tube;
a fastener having plural inward claws at a first end thereof; a threaded portion thereon and a second end mounted to a top end of said outer tube;
a sleeve embracing said fastener and said top end of said outer tube, said sleeve having a threaded portion therein and an inclined surface situated above said threaded portion of said sleeve;
a lamp head connected to a top end of said inner tube;
a base mounted to a rear end of said outer tube; and
a cable received within said inner tube and electronically connected to said lamp head for providing electric power to said lamp head;
wherein said inner tube is slidably received through said fastener and in said outer tube, said threaded portion of said sleeve being engaged with said threaded portion of said fastener, in order said inclined surface of said sleeve can press against said inward claws to hold said inner tube in position.

6. The height adjustable lamp as claimed in claim 5, wherein said positioning device comprises a slot thereon for being engaged with said elongated rail of said outer tube.

7. The height adjustable lamp as claimed in claim 5, wherein said second end of said fastener is threadly engaged within said top end of said outer tube.

8. The height adjustable lamp as claimed in claim 5, wherein said cable is a spiral cable.

9. The height adjustable lamp as claimed in claim 8, wherein said fastener cooperates with said positioning device to prevent said inner tube from sliding fully off said outer tube.

10. The height adjustable lamp as claimed in claim 9, wherein said inward claws are flexible.

11. A height adjustable lamp:
an inner tube;
a positioning device connected to a rear end of said inner tube, said positioning device having a non-circular outer cross section;
an outer tube having a non-circular inner cross section engaged with said non-circular outer cross section of said positioning device for preventing said inner tube from rotating in said outer tube;
a fastener having plural inward claws at a first end thereof; a threaded portion thereon and a second end mounted to a top end of said outer tube;
a sleeve embracing said fastener and said top end of said outer tube, said sleeve having a threaded portion therein and an inclined surface situated above said threaded portion of said sleeve;
a lamp head connected to a top end of said inner tube; and
a base mounted to a rear end of said outer tube;
wherein said inner tube is slidably received through said fastener and in said outer tube, said threaded portion of said sleeve being engaged with said threaded portion of said fastener, in order said inclined surface of said sleeve can press against said inward claws to hold said inner tube in position.

12. The height adjustable lamp as claimed in claim 11, further comprising a cable received within said inner tube, said cable being electronically connected to said lamp head for providing electric power to said lamp head.

13. The height adjustable lamp as claimed in claim 11, wherein said non-circular inner cross section of said outer tube and said non-circular outer cross section of said positioning device is of a polygon shape.

14. The height adjustable lamp as claimed in claim 11, wherein said second end of said fastener is threadly engaged within said top end of said outer tube.

15. The height adjustable lamp as claimed in claim 12, wherein said cable is a spiral cable.

16. The height adjustable lamp as claimed in claim 14, wherein said fastener cooperates with said positioning device to prevent said inner tube from sliding fully off said outer tube.

17. The height adjustable lamp as claimed in claim 16, wherein said inward claws are flexible.
